(19) United States
(12) Patent Application Publication
(10) Pub. No.: US 2013/0043081 A1
(43) Pub. Date: Feb. 21, 2013

(54) MULTI-FUNCTION TOUCH PANEL

(71) Applicant: SHENG-HSIUNG CHEN, Changhua (TW)

(72) Inventor: SHENG-HSIUNG CHEN, Changhua (TW)

(21) Appl. No.: 13/212,205

(22) Filed: Aug. 18, 2011

(51) Int. Cl. G06F 3/045; G06F 3/041

(52) U.S. Cl. 178/18.05; 178/18.03

(57) ABSTRACT

A multi-function touch panel includes a transparent substrate and an opaque color frame formed by an edge of the substrate so as to form a visible area and a shelter area on the substrate. A transparent touch sensing unit is formed to the visible area on a surface of the substrate. A signal wiring under the shelter area is formed around the touch sensing unit. The signal wiring is electrically connected between the touch sensing unit and a first signal bus. A flat antenna is insulatedly formed outside the signal wiring under the shelter area. Two ends of the flat antenna are electrically connected to a second signal bus. The color frame is made of insulated material. The first signal bus and the second signal bus are integrated as one signal bus.

### FIELD OF THE INVENTION

The present invention relates to touch panel, and particular to a multi-function touch panel capable of transmitting and receiving wireless signal.

### DESCRIPTION OF THE PRIOR ART

Wireless communication technology is widely applied to various electronic devices. For the portable electronic devices, the wireless communication could be an essential. Except the functions and accessories, the outer appearances are also an important part for the portable devices such as mobile phone, laptop, or tablet PC. Therefore, the antenna for wireless communication of such device is hidden from the case. However, the hidden antenna also has difficulties of limitation in interior space and metal interference. To prevent shield effect by metal case, some device will use plastic or non-metal case instead of metal case so that the mechanical strength, endurance, and the anticorrosive must be sacrificed. To compromise between the visual fineness and shield effect of metal, some devices will use a metal frame arranged to a peripheral thereof as an antenna. Some devices use composite case by metal and non-metal to prevent the antenna being shielded, but the color difference between the materials will still damage the outer appearance of the product.

### SUMMARY OF THE PRESENT INVENTION

Accordingly, the primary object of the present invention is to provide a touch panel capable of transmitting and receiving wireless signal. An antenna is integrated to a touch panel so that wireless signal transmission can be achieved without prior assembly of external antenna. The space limit, signal interference, and material limitation of case of an electronic device can be solved. The flat antenna can be also integrated to touch sensing circuit so as to reduce the manufacture processes.

To achieve above objects, the present invention provides a touch panel having a substrate, color frame, transparent touch sensing unit, and a flat antenna. The opaque color frame made of insulated material is formed by an edge of the substrate so as to form a visible area and a shelter area on the substrate. The transparent touch sensing unit is formed to the visible area of the substrate. A signal wiring electrically connected to the touch sensing unit is formed under the shelter area. A signal generated by the touch sensing unit through a finger or conductor touch will be transmitted to a signal processing circuit through a signal wiring, the signal processing circuit will locate the position of touch by detection of the variation of the signal. The flat antenna for transmitting and receiving wireless signal is insulatedly arranged outside the signal wiring under covering by the shelter area of the substrate. The flat antenna is sheltered by the color frame so as to maintain the outer-appearance and the flatness as well as the utilization of space. The signal transmission and receiving of the flat antenna won't be shielded or interfered by the color frame made of insulated material. Moreover, the flat antenna can be integrated to signal wiring so that the process of forming and connecting the antenna can be skipped.

The various objects and advantages of the present invention will be more readily understood from the following detailed description when read in conjunction with the appended drawing.

### BRIEF DESCRIPTION OF THE DRAWINGS

FIG. 1 is a schematic view showing a bottom surface of the substrate of the first embodiment of the present invention.

FIG. 2 is a cross-section view through a C-C line in FIG. 1.

FIG. 3 is a schematic view showing a bottom surface of the substrate of the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

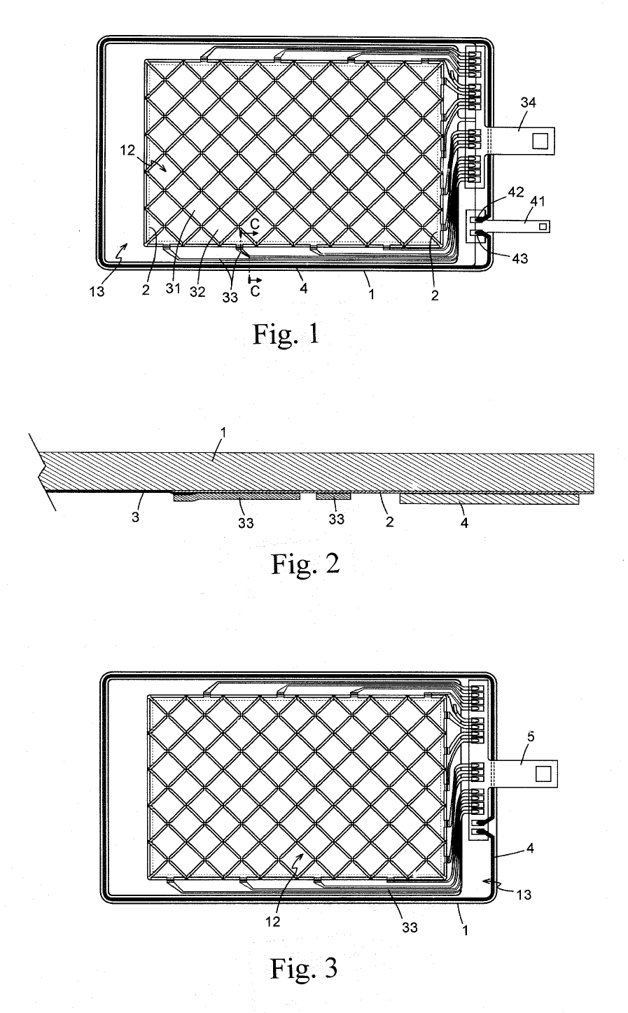

Referring to FIGS. 1 and 2, a preferable embodiment according to present invention is illustrated. The multi-function touch panel includes a substrate 1, color frame 2, transparent touch sensing unit 3, and a flat antenna 4. The substrate 1 is a transparent thin plate of high mechanical strength such as a plate of glass, polymethylmethacrylate (PMMA), Polycarbonate (PC), Polythylene terephthalate (PET), or Cyclic Olefin Copolymer (COC). The substrate 1 could be a soft or hard plate made of other material. The substrate 1 is a flat plate having two flat surfaces or an uneven plate having convex or concave surfaces. Moreover, the substrate 1 has a surface layer made of a plurality of functional film such as polarizer, filter, anti-scratch film, or a hard coating so that the surface of the substrate is anti-scratching, unreflecting, dust-proof, anti-glare, and anticorrosive.

The color frame 2 is formed along an edge of the bottom surface of the substrate 1. The color frame 2 is an opaque or nearly opaque film made of insulated material (non-metal). The insulated material can be ink, photoresist or other material. The color frame 2 is a film of a thickness between 0.5 to 15 μm formed by printing or coating. A visible are 12 and shelter are 13 are thus formed to a center and edge of the substrate 1 respectively.

The transparent touch sensing unit 3 is formed within the visible area 12 of the bottom surface of the substrate 1. The touch sensing unit 3 has an upper capacitive sensing layer and a lower capacitive sensing layer insulatedly from each other. A plurality of X-trace 31 is formed to the upper capacitive sensing layer, and a plurality of Y-trace 32 is formed to the lower capacitive sensing layer. The capacitive sensing layers are transparent films made of Indium Tin Oxide (ITO), and the X,Y-traces are formed by removing undesired area of the ITO film through etching process or laser process. A signal wiring 33 is formed around the touch sensing unit 3 and under the shelter are 13 of the substrate 1. The signal wiring 33 is metal wiring made of Ag, Cu, Mo/Al/Mo or Ag/Pu/Cu by means of photolithography. An end of the X and Y traces is electrically connected to the signal wiring 33, and the signal wiring 33 is electrically connected to a first signal bus 34 so that the sensing signal induced by the touch sensing unit 3 can be transmitted to a following signal processing circuit. The above embodiment is applied to a capacitive touch panel, the present invention can be also applied to a resistive or electromagnetic touch panel.

The flat antenna 4 is insulatedly arranged outside the signal wiring 33 under covering by the shelter area 13. Preferably, a gap larger than 1 mm is preserved between the flat antenna 4 and the signal wiring 33 so as to prevent electro-magnetic interference. The flat antenna 4 is made of Cu/Ni/Ti, the alloy mentioned above, or any other materials having good conductivity. Moreover, the two ends of the flat antenna 4 are electrically connected to a feed-in node 42 and a ground 43 of a second signal bus 41.

The signal wiring 33 and the flat antenna 4 of the above touch panel will be sheltered by the color frame 2 so as to maintain the outer-appearance and the flatness. The signal transmission and receiving of the flat antenna 4 won't be interfered by the color frame 2 made of insulated material. The touch panel of the present invention can be applied to a LCM (Liquid Crystal Module) so that the user can easily perform an input by finger touch following the instruction. When a finger or a conductor touches or slide on a certain position on the surface of the touch panel, the signal processing circuit will locate the position by detection of the variation of the capacitance. Except the touch sensing unit 3, the flat antenna 4 integrated to the touch panel can provide the capability of wireless transmission and receiving. For the integration of the flat antenna 4 and the touch panel, the size of electronic device can be further minimized.

Referring to FIG. 3, another embodiment of the present invention having a flat antenna arranged to a signal wiring is illustrated. The process of forming and connecting the antenna can be skipped. The signal wiring 33 and the flat antenna 4 are both pattern made of Ag, Cu, Mo/Al/Mo or Ag/Pu/Cu under the shelter area 13 of a substrate by means of photolithography. Moreover, the first signal wiring 33 and the second signal wiring 41 of the previous embodiment are integrated as a single signal bus 5 in the embodiment, and the signal wiring 33 and the flat antenna 4 are electrically connected to the signal bus 5.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A touch panel assembly comprising:
a highly transparent substrate having a good mechanical strength;
a color frame of a an opaque or nearly opaque film formed by an edge of a surface of the substrate; a central visible area and a shelter area beneath the color frame being separated by the color frame; the color frame being made of insulated material;
a transparent touch sensing unit formed within the visible area of the surface of the substrate; a signal wiring being formed around the touch sensing unit; the signal wiring being formed within the shelter area of the substrate; the signal wiring electrically connected to the touch sensing unit integrating and conducting signal to a first signal bus; and
a flat antenna insulatedly arranged outside the signal wiring beneath the shelter area of the substrate; two ends of the flat antenna being electrically connected to a second signal bus.

2. The multi-function touch panel as claimed in claim 1, wherein the substrate is made of one of glass, polymethylmethacrylate (PMMA), Polycarbonate (PC), Polythylene terephthalate (PET), or Cyclic Olefin Copolymer (COC).

3. The multi-function touch panel as claimed in claim 2, wherein the substrate is one of a flat plate or an uneven plate having convex or concave surfaces.

4. The multi-function touch panel as claimed in claim 1, wherein the color frame is a film having a thickness between 0.5 to 15 μm.

5. The multi-function touch panel as claimed in claim 1, wherein the touch sensing unit is one of a capacitive, resistive, or electric-magnetic touch sensing unit.

6. The multi-function touch panel as claimed in claim 1, wherein the flat antenna is made of Cu, Ni, Ti or any other alloy having good conductivity.

7. The multi-function touch panel as claimed in claim 1, wherein the signal wiring and the flat antenna are both metal patterns made of Ag, Cu, Mo/Al/MO, or Ag/Pu/Cu under the shelter area of the substrate by means of photolithography.

8. The multi-function touch panel as claimed in claim 1, wherein a gap larger than 1 mm is preserved between the flat antenna and the signal wiring.

9. The multi-function touch panel as claimed in claim 1, wherein the flat antenna is a film of a thickness less than 0.2 mm.

10. The multi-function touch panel as claimed in claim 1, wherein the first signal bus and the second signal bus is integrated as a one signal bus.
